(19) United States
(12) Patent Application Publication
(10) Pub. No.: US 2024/0309692 A1
(43) Pub. Date: Sep. 19, 2024

(54) SYSTEM AND METHOD OF COMPENSATING FOR DOOR OPERATING FORCE ON INCLINED ROAD

(71) Applicants: Hyundai Motor Company, Seoul (KR); Kia Corporation, Seoul (KR)

(72) Inventor: Sang-Heon LEE, Gwacheon-Si (KR)

(73) Assignees: Hyundai Motor Company, Seoul (KR); Kia Corporation, Seoul (KR)

(21) Appl. No.: 18/368,416

(22) Filed: Sep. 14, 2023

(30) Foreign Application Priority Data
Mar. 16, 2023 (KR) 10-2023-0034568

(51) Int. Cl. E05F 15/611

(52) U.S. Cl. CPC E05F 15/611; E05Y 2400/315; E05Y 2400/44; E05Y 2900/531

(57) ABSTRACT

A method of compensating for the door operating force on the inclined road surface includes a signal input operation of inputting a sensor signals required for determining the compensating of the operating force of the door to the controller, a stop determination operation of determining, by the controller, whether the vehicle is stopping, a gravitational force determination operation of determining, by the controller, the gravitational forces acting in the transverse direction of the door with the input sensor signals, a compensating torque determination operation of determining, by the controller, the compensating torques to be output from the actuator to offset the gravitational forces, and an operating force compensation operation of compensating for, by the controller, the operating force when the door is opened or closed with the compensating forces.

### CROSS-REFERENCE TO RELATED APPLICATION

The present application claims priority to Korean Patent Application No. 10-2023-0034568, filed on Mar. 16, 2023, the entire contents of which is incorporated herein for all purposes by this reference.

### BACKGROUND OF THE PRESENT DISCLOSURE

### Field of the Present Disclosure

The present disclosure relates to a system and method of compensating for a door operating force on an inclined road surface, which may open or close a door on an inclined road surface with the same operating force as on a flat road.

### Description of Related Art

Doors for occupants to get on or off are installed on side surfaces of a vehicle.

There is a swing-type door in which the door is opened or closed about a rotation shaft perpendicular to a ground surface.

The swing-type door does not generate a gravitational force due to gravity when opened or closed on a flat road. Because the center of gravity of the door moves on a horizontal plane when the door is opened or closed, an occupant may open or close the door without being affected by gravity.

However, when the vehicle is stopped on an inclined road surface, the gravitational force additionally acts on the door, and thus it is difficult for the occupants to open or close the door, or the door is opened or closed at an excessive speed.

When opening and closing directions of the door and a direction in which the gravitational force acts are opposite directions, an additional force is required to open or close the door. For example, when the door is closed in FIG. 1A, when the door is opened in FIG. 1B, when a driver's seat side door (right side in the drawing) is opened in FIG. 1C, and when a passenger side door (left side in the drawing) in FIG. 1D is opened, the door needs to be operated with more force than on the flat road.

Meanwhile, when the opening and closing directions of the door and the direction in which the gravitational force acts are the same, the door may be opened or closed easily and at a faster speed than the occupant intends, so there is a concern that the occupant is injured or the door or a portion on which the door is mounted is damaged. For instance, when the door is opened in FIG. 1A, when the door is closed in FIG. 1B, when the passenger side door is opened in FIG. 1C, and when the driver side door is opened in FIG. 1D, because the door is opened or closed too easily, there is a problem that the occupant is injured or the door or the vehicle is damaged.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system and method of compensating for a door operating force on an inclined road surface, which compensate for an operating force for opening or closing a door so that the door of a vehicle may be opened or closed on an inclined road surface with the same operating force as on a flat road.

To achieve the object, a system for compensating for a door operating force on an inclined road surface according to an exemplary embodiment of the present disclosure may include a door opened or closed by rotating about a rotation shaft of a body of a vehicle, an actuator coupled to the door and configured to operate the door with compensating torques for offsetting gravitational forces acting on the door by a weight of the door and gravity, and a controller electrically connected to the actuator and configured to determine the gravitational forces acting on the door, determine the compensating torques to offset the gravitational forces, and compensate for the door operating force when the door is opened in a state in which the vehicle has stopped on the inclined road surface.

The controller may include a control amount calculator configured to determine the gravitational forces applied to the door and to determine the compensating torques, and a driving controller configured to drive the actuator to operate the door with the compensating torques determined by the control amount calculator.

The control amount calculator may include a stop determiner configured to determine whether the vehicle has stopped, a gravitational force calculator configured to determine a gravitational force applied to the door in a transverse direction, and a compensating torque calculator configured to determine compensating torques to be output from the actuator to offset the gravitational forces.

The stop determiner may be configured to determine that the vehicle is stopping when a state in which each wheel speed of the vehicle is 0 kph and a position of a gear is in a P stage is maintained for a preset time or longer than the preset time.

The stop determiner may be configured to determine that the vehicle is stopping when a state in which each wheel speed of the vehicle is 0 kph, a braking pedal of the vehicle is in operation, and a pressure of a master cylinder in the vehicle is a preset value or higher than the preset value is maintained for a preset time or longer than the preset time.

The gravitational force calculator may be configured to determine the gravitational forces acting on a left door and a right door of the vehicle, respectively after receiving a longitudinal acceleration and a transverse acceleration applied to the vehicle, and an opening angle of the door.

The gravitational force calculator may be configured to determine the gravitational forces acting on the left door and the right door of the vehicle, respectively, by the following equation:

Gravitational force acting on the left door: L_{y}(θ,φ,α)=−g·sin θ·sin α+g·sin φ·cos θ·cos α, and

Gravitational force acting on the right door: R_{y}(θ,φ,α)=−g·sin θ·sin α−g·sin φ·coxθ·cos α

(Here, α: opening angle of the door, θ: longitudinal inclination, and φ: transverse inclination).

The compensating torque calculator may be configured to determine the compensating torques of the left door and the right door of the vehicle by the following equation:

Compensating torque of the left door: T_{L}=M·L_{cg}·L_{y}, and

Compensating torque of the right door: T_{R}=M·L_{cg}·R_{y}

(Here, M: mass of the door, L_{cg}: distance between the rotation shaft of the door and the center of gravity, and L_{y} and R_{y}: gravitational forces respectively acting on the left door and the right door).

The driving controller may compensate for opening and closing forces of the door with the compensating torques when absolute values of the compensating torques are greater than a predetermined reference torque at which the compensating of the operating force for opening or closing the door is required.

Meanwhile, a method of compensating for a door operating force on an inclined road surface includes a signal input operation of inputting sensor signals, which are required for determining the compensating of the operating force of the door, to a controller, a stop determination operation of determining, by the controller, whether a vehicle is stopping, a gravitational force determination operation of determining, by the controller, gravitational forces acting on the door in a transverse direction of the vehicle with the input sensor signals, a compensating torque determination operation of determining, by the controller, compensating torques to be output from an actuator to offset the gravitational forces, and an operating force compensation operation of compensating, by the controller, for an operating force when the door is opened or closed with the compensating torques.

The stop determination operation may include determining that the vehicle is stopping when a state in which each wheel speed of the vehicle is 0 kph and a position of a gear is in a P stage is maintained for a preset time or longer than the preset time.

The stop determination operation may include determining that the vehicle is stopping when a state in which each wheel speed of the vehicle is 0 kph, a braking pedal of the vehicle is in operation, and a pressure of a master cylinder in the vehicle is a preset value or higher than the preset value is maintained for a preset time or longer than the preset time.

In the gravitational force determination operation, the gravitational forces acting on a left door and a right door of the vehicle, respectively may be determined by the following equation:

Gravitational force acting on the left door: L_{y}(θ,φ,α)=−g·sin θ·sin α+g·sin φ·cos θ·cos α, and

Gravitational force acting on the right door: R_{y}(θ,φ,α)=−g·sin θ·sin α−g·sin φ·coxθ·cos α

(Here, α: opening angle of the door, θ: longitudinal inclination, and φ: transverse inclination).

In the compensating torque determination operation, the compensating torques of the left door and the right door of the vehicle may be determined by the following equation:

Compensating torque of the left door: T_{L}=M·L_{cg}·L_{y}, and

Compensating torque of the right door: T_{R}=M·L_{cg}·R_{y}

(Here, M: mass of the door, L_{cg}: distance between the rotation shaft of the door and the center of gravity, and Ly and R_{y}: gravitational forces respectively acting on the left door and the right door).

The method may further include a compensating torque comparison operation of comparing absolute values of the compensating torques with a predetermined reference torque at which the compensating of the operating force is required between the compensating torque determination operation and the operating force compensation operation, wherein in the compensating torque comparison operation, the operating force compensation operation may be performed when the absolute values of the compensating torques are greater than the reference torque.

The signal input operation may include inputting signals including each wheel speed, a position of a gear, whether a braking pedal of the vehicle is operated, a pressure of a master cylinder, whether a door lock of the vehicle is opened or closed, a longitudinal acceleration, a transverse acceleration, and an opening angle of the door to the controller.

In stop determination operation, whether the door lock of the door is in an unlocked state is determined, and when the door lock is unlocked, the gravitational force determination operation may be performed.

The method may further include a locking determination operation of determining whether the door lock is in the unlocked state after the operating force compensation operation, when the door lock is not in the unlocked state, the method may return to the signal input operation.

The controller may repeatedly perform the signal input operation to the operating force compensation operation every predetermined period.

According to the system and method for compensating for the door operating force on the inclined road surface according to an exemplary embodiment of the present disclosure including the above configuration, it is possible to open or close the door with the same force as on the flat road regardless of the inclination of the road surface on which the vehicle is positioned, improving the convenience of the opening and closing of the door.

When the opening and closing directions of the door and the direction of the gravitational force are opposite directions, the operating force of the door may be compensated to be increased as much as the gravitational force is applied, easily opening or closing the door.

When the opening and closing directions of the door and the direction of the gravitational force are the same, the operating force of the door may be compensated to be reduced as much as the gravitational force, preventing the door from being opened at an excessively speed. Because the door is opened or closed at an appropriate speed, it is possible to prevent the occupant's injury and the damage to the door and the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A, FIG. 1B, FIG. 1C, and FIG. 1D are schematic diagrams illustrating a state in which a vehicle has stopped on an inclined road surface with an angle (0), respectively.

FIG. 2 is a block diagram illustrating a system for compensating for a door operating force on an inclined road surface according to an exemplary embodiment of the present disclosure.

FIG. 3 is a flowchart illustrating a method of compensating for a door operating force on an inclined road surface according to an exemplary embodiment of the present disclosure.

FIG. 4 is a schematic diagram illustrating the relationship between a coordinate system of a vehicle and a coordinate system of a door.

FIG. 5 is a view exemplarily illustrating a coordinate system illustrating forces acting on the vehicle and the door when a door of the vehicle is closed.

FIG. 6 is a view exemplarily illustrating a coordinate system illustrating forces acting on the vehicle and the door when the door of the vehicle is opened.

FIG. 7 is a schematic diagram illustrating a principle of offsetting a gravitational force acting on the door of the vehicle.

FIG. 8 is a graph illustrating a gravitational force acting on the door of the vehicle for each opening angle of the door on a flat road.

FIG. 9 is a graph illustrating a gravitational force acting on the door of the vehicle for each opening angle of the door on a downward inclined road surface.

FIG. 10 is a graph illustrating a gravitational force acting on the door of the vehicle for each opening angle of the door on an upward inclined road surface.

FIG. 11 is a graph illustrating a gravitational force acting on the door of the vehicle for each opening angle of the door on an inclined road surface with a high slope on a driver's seat side.

FIG. 12 is a graph illustrating a gravitational force acting on the door of the vehicle for each opening angle of the door on an upward inclined road surface with a high slope on a passenger seat side.

FIG. 13 is a graph illustrating a gravitational force acting on the door of the vehicle for each opening angle of the door on a composite inclined road surface.

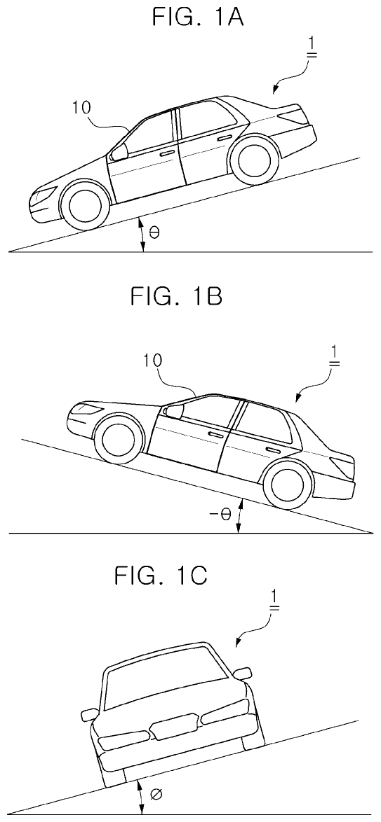

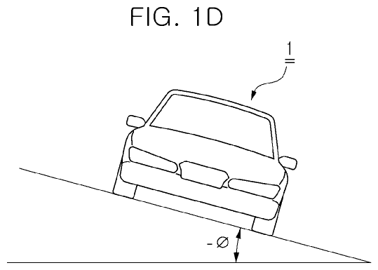

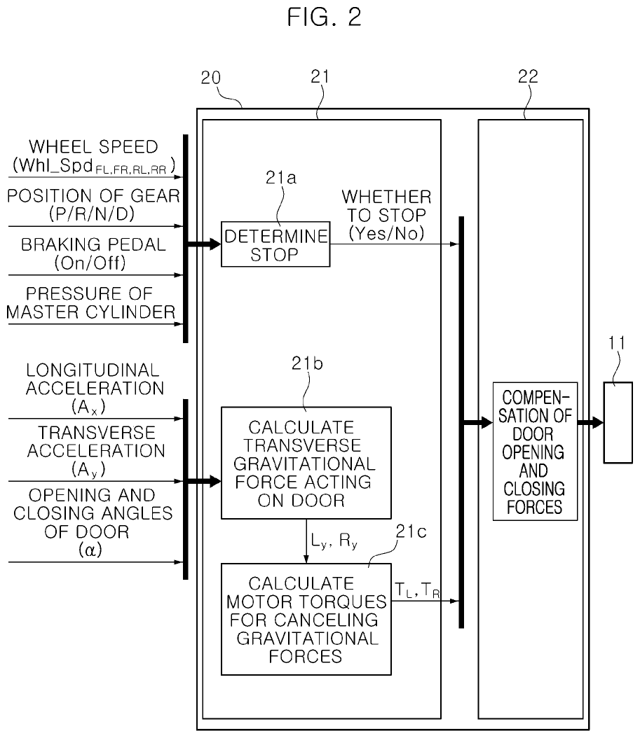

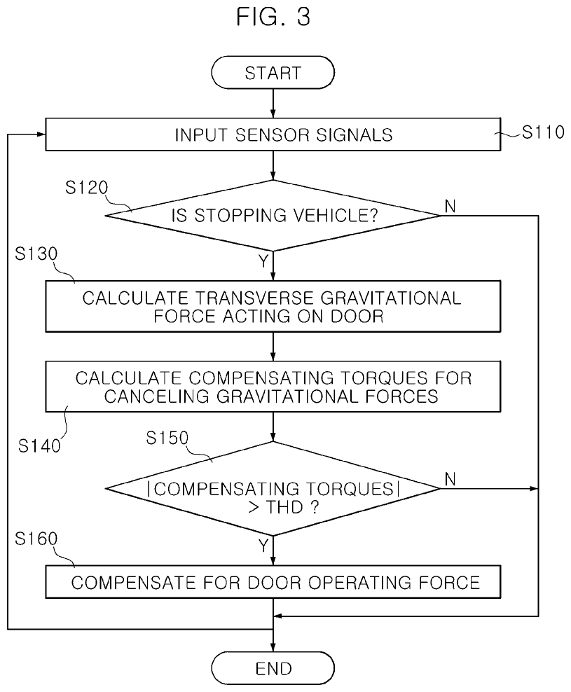

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a system and method for compensating for a door operating force on an inclined road surface according to an exemplary embodiment of the present disclosure will be described in detail with reference to the accompanying drawings.

The system for compensating for the door operating force on the inclined road surface according to an exemplary embodiment of the present disclosure includes a door 10 opened or closed by rotating about a rotation shaft S of a body of a vehicle 1, an actuator 11 for operating the door 10 with compensating torques T_{L} and T_{R} for offsetting gravitational forces L_{y} and R_{y} acting on the door 10 by a weight of the door 10 and gravity, and a controller 20 for determining the gravitational forces L_{y} and R_{y} acting on the door 10, determining the compensating torques T_{L} and T_{R} offsetting the gravitational forces L_{y} and R_{y}, and compensating the operating force of the door 10 by the actuator 11 when the door 10 is opened in a state in which the vehicle 1 has stopped on an inclined surface.

The door 10 may be provided on a side surface of the vehicle and may be opened or closed for occupants to get on or off. Typically, the door 10 may be provided to rotate around the rotation shaft S of a body of the vehicle.

The actuator 11 operates the door 10 with the compensating torques T_{L} and T_{R} for the gravitational forces applied to the door 10 by gravity. When the vehicle stops on the inclined road surface, the weight of the door 10 and the gravitational forces L_{y} and R_{y} due to the inclination of the road surface act thereon. The gravitational forces L_{y} and R_{y} are forces at which a mass of the door 10 acts along the inclination. The actuator 11 compensates for the gravitational forces L_{y} and R_{y} on the inclined road surface so that the occupant opens or closes the door 10 with the same force as opening and closing the door 10 on a flat road. The actuator 11 adds as much as the gravitational force to an occupant's manipulation force depending on the inclination of the road surface (in the case of an upward inclination). Conversely, in the case of a downward inclination, the actuator 11 acts as much as the gravitational force in an opposite direction to the occupant's manipulating force.

The actuator 11 may be provided in a form of a motor and connected to the rotation shaft S. Because the actuator 11 rotates the rotation shaft S, it is possible to compensate for the gravitational forces L_{y} and R_{y}.

Alternatively, the actuator 11 may be provided as a variable damper and connected to the rotation shaft S to compensate for the gravitational forces L_{y} and R_{y}.

Furthermore, the actuator 11 may be provided in a form of a hydraulic cylinder or a pneumatic cylinder and provided in a form of directly connecting the vehicle body and the door 10 so that the actuator 11 may directly push or pull the door 10.

The opening angle sensor 12 measures an opening angle of the door 10. The gravitational forces L_{y} and R_{y} acting in a transverse direction of the door 10 varies depending on both the inclination of the road surface on which the vehicle 1 stops and an opening angle of the door 10. Therefore, the opening angle of the door 10 may be measured by the opening angle sensor 12.

The controller 12 is configured to determine whether the gravitational forces L_{y} and R_{y} act on the door 10 after the vehicle stops on the inclined road surface, is configured to determine the compensating torques T_{L} and T_{R} to offset the gravitational forces L_{y} and R_{y}, and allows the compensating torques T_{L} and T_{R} to act by the actuator 11 when the door 10 is opened or closed.

The controller 12 includes a control amount calculator 21 for determining the gravitational forces L_{y} and R_{y} applied to the door 10 and determining the compensating torques T_{L} and T_{R} and a driving controller 22 for driving the actuator 11 with the compensating torques T_{L} and T_{R} determined by the control amount calculator 21.

According to an exemplary embodiment of the present disclosure, each of the control amount calculator 21 and the driving controller 22 may be a processor (e.g., computer, microprocessor, CPU, ASIC, circuitry, logic circuits, etc.). Each of the control amount calculator 21 and the driving controller 22 may be implemented by a non-transitory memory storing, e.g., a program(s), software instructions reproducing algorithms, etc., which, when executed, controls operations of various components of the vehicle, and a processor configured to execute the program(s), software instructions reproducing algorithms, etc. Alternatively, the control amount calculator 21 and the driving controller be integrated in a single processor.

The control amount calculator 21 includes a stop determiner 21a for determining whether the vehicle stops, a gravitational force calculator 21b for determining the gravitational forces L_{y} and R_{y} acting on the door 10, and a compensating torque calculator 21c for determining the compensating torques T_{L} and T_{R} to be output from the actuator 11.

The stop determiner 21a is configured to determine whether the vehicle stops. The stop determiner 21a receives a wheel speed of each wheel, for example, a wheel speed Whl_Spd_{FL} of a front left wheel, a wheel speed Whl_Spd_{FR} of a front right wheel, a wheel speed Whl_Spd_{RL} of a rear left wheel, and a wheel speed Whl_Spd_{RR} of a rear right wheel when the vehicle is provided with four wheels. Furthermore, the stop determiner 21a receives a gear position of the vehicle, whether a brake pedal operates, and a pressure of a master cylinder according to an operation of the brake pedal. Furthermore, when a door lock of the door is being locked, it is not necessary to compensate for the torque when the door is opened or closed, and thus the stop determiner 21a also receives whether the door lock is locked.

The stop determiner 21a is configured to determine that the vehicle is stopping when a state in which each wheel speed of the vehicle is 0 kph and a gear position is in a P stage is maintained for a preset time or longer than the preset time. This is a condition for determining whether the vehicle stops when the gear is in the state of being the P stage.

Alternatively, the stop determiner 21a is configured to determine that the vehicle is stopping when a state in which each wheel speed of the vehicle is 0 kph, the brake pedal is in operation, and the pressure of the master cylinder is higher than or equal to a preset value is maintained for the preset time or longer than the preset time. This is a condition considering a state in which a driver manipulates the brake pedal to stop the vehicle when the gear is not in the P stage, that is, in a situation in which the gear is in an R, N, or D stage.

The gravitational force calculator 21b is configured to determine the weight of the door 10 and the gravitational forces L_{y} and R_{y} in the transverse direction due to the inclination of the road surface after the vehicle stops on the inclined road surface. The gravitational force calculator 21b receives and is configured to determine a longitudinal acceleration Aₓ and a transverse acceleration A_{y} applied to the vehicle, and an opening angle α of the door 10.

When the vehicle is stopping, only the gravitational forces L_{y} and R_{y} acting by gravity act on the door 10, which has the same meaning as the inclination of the road surface. The opening and closing of the door 10 may be performed only in a stopped state. Therefore, the gravitational forces L_{y} and R_{y} acting on the door in the transverse direction may be determined using the longitudinal acceleration and the transverse acceleration which may be measured in the vehicle 1 instead of an estimated inclination value of the road surface because an accurate inclination value of the road surface may not be measured in the vehicle.

Each of the longitudinal acceleration Aₓ and the transverse acceleration A_{y} applied to the vehicle in the state in which the vehicle has stopped are as follows.

$$\begin{matrix}{A}_{x} = - g \cdot sin θ \\ {A}_{y} = g \cdot sin φ \cdot cos θ\end{matrix}$$

(Here, g: gravitational acceleration, θ: longitudinal inclination, and φ: transverse inclination)

An acceleration sensor configured for measuring the longitudinal acceleration, the transverse acceleration, and a vertical acceleration of the vehicle 1 may be mounted to measure a longitudinal acceleration, a transverse acceleration, and a vertical acceleration that match a front and rear direction, a left and right direction, and a height direction of the vehicle.

Since the vehicle 1 is stopping, only the gravitational acceleration may be acting, and the gravitational acceleration may be expressed as follows because it is a gravitational component due to the inclination on which the vehicle has stopped.

$$[ \begin{matrix}Ax \\ Ay \\ Az\end{matrix} ] = [ \begin{matrix}- g sin θ \\ g sin ϕ cos θ \\ g cos ϕ cos θ\end{matrix} ]$$

A rotation matrix representing a correlation between two coordinate systems crossing each other at the rotation angle α is defined as follows.

$${R}_{A}^{D} = [ \begin{matrix}{cos}_{α} & {sin}_{α} & 0 \\ - {sin}_{α} & {cos}_{α} & 0 \\ 0 & 0 & 1\end{matrix} ]$$

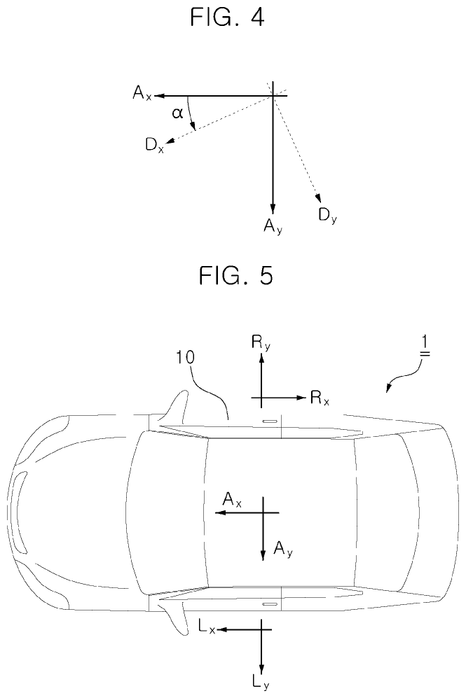

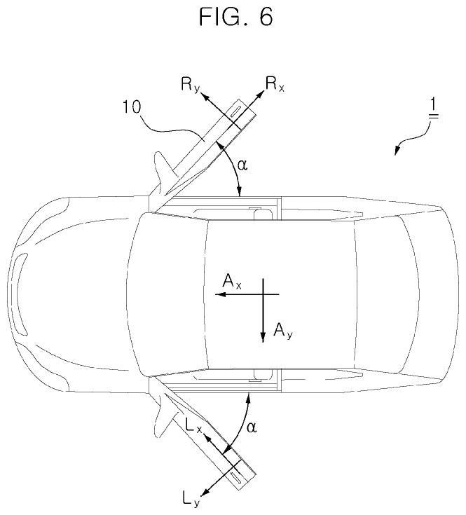

FIG. 4 illustrates the relationship between the coordinate system (indicated by solid lines) of the vehicle and the coordinate system (indicated by dotted lines) of the door that has rotated the coordinate system of the vehicle at the opening angle α of the door 10, FIG. 5 illustrates forces acting on the coordinate system of the vehicle and the coordinate system of the door when the door 10 is closed, and FIG. 6 illustrates forces acting on the coordinate system of the vehicle and the coordinate system of the door when the door 10 is opened at the opening angle α.

When the door 10 is opened at the opening angle α, the coordinate system of the door 10 may be displayed as a rotation matrix in which the opening angle of the door from the vehicle 1 coordinate system is used as the rotation angle α.

$$[ \begin{matrix}Dx \\ Dy \\ Dz\end{matrix} ] [ \begin{matrix}{cos}_{α} & {sin}_{α} & 0 \\ - {sin}_{α} & {cos}_{α} & 0 \\ 0 & 0 & 1\end{matrix} ] [ \begin{matrix}Ax \\ Ay \\ Az\end{matrix} ]$$

Therefore, the transverse gravitational forces L_{y} and R_{y} acting on the door 10 are as follows.

$${D}_{y} = - {A}_{x} \cdot sin α + {A}_{y} \cdot cos α$$

When each of the left door 10 and the right door 10 of the vehicle is opened at the opening angle α, the opening angle of the left door 10 may be expressed as “−α,” and the opening angle of the right door 10 may be expressed as “180°+α.”

Substituting each of them into D_{y}, the result may be obtained as follow:

$$\begin{matrix}{L}_{y} ( {A}_{x} , {A}_{y} , α ) = {A}_{x} \cdot sin α + {A}_{y} \cdot cos α , and \\ {R}_{y} ( {A}_{x} , {A}_{y} , α ) = {A}_{x} \cdot sin α - {A}_{y} \cdot cos α\end{matrix}$$

(Here, Aₓ: longitudinal acceleration, A_{y}: transverse acceleration, and α: opening angle of the door).

Expressing this as a function of the inclination angle, the gravitational force calculator 21b ultimately is configured to determine the gravitational forces L_{y} and R_{y} acting on the left and right doors by the following equation:

Gravitational force acting on the left door: L_{y}(θ,φ,α)=−g·sin θ·sin α+g·sin φ·cos θ·cos α, and gravitational force acting on the right door: R_{y}(θ,φ,α)=−g·sin θ·sin α−g·sin φ·coxθ·cos α.

(Here, α: opening angle of the door, θ: longitudinal inclination, and φ: transverse inclination).

Here, when signs of the determined gravitational forces L_{y} and R_{y} are positive numbers, this means that the gravitational forces act in a direction of closing the door 10, and when the signs of the gravitational forces L_{y} and R_{y} are negative numbers, this means that the gravitational forces act in a direction of opening the door 10.

The compensating torque calculator 21c is configured to determine the compensating torques T_{L} and T_{R} to be output from the actuator 11 to offset the gravitational forces L_{y} and R_{y}. Since the gravitational forces L_{y} and R_{y} act on the center of gravity C.G of the door 10, torques may be generated with respect to the rotation shaft S of the door 10. The generated torques change the occupant's manipulating force of opening or closing the door 10 on the flat road. Therefore, the gravitational forces L_{y} and R_{y} may be offset by the compensating torques T_{L} and T_{R} having the same magnitude as the torque generated by the transverse gravitational forces L_{y} and R_{y} and having opposite directions. The compensating torque calculator 21c is configured to determine the compensating torques T_{L} and T_{R} to be output from the actuator 11.

The compensating torque calculator 21c is configured to determine the compensating torques T_{L} and T_{R} to be applied to the left door 10 and the right door 10 of the vehicle by the following equation:

Compensating torque of the left door: T_{L}=M·L_{cg}·L_{y}, and Compensating torque of the right door: T_{R}=M·L_{cg}·R_{y}

(Here, M: mass of the door, L_{cg}: distance between the rotation shaft of the door and the center of gravity, and Ly and R_{y}: gravitational forces respectively acting on the left door and the right door).

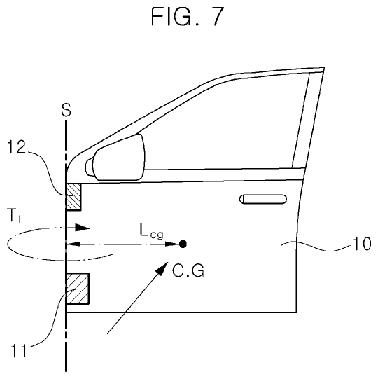

That is, as illustrated in FIG. 7, when the transverse gravitational forces L_{y} and R_{y} act on the center of gravity C.G of the door 10 at the distance L_{cg} from the rotation shaft S of the door 10, a torque acts on the rotation shaft S. Therefore, to offset this, because the compensating torques T_{L} and T_{R}, which include the same magnitude and opposite directions, need to act, the compensating torque calculator 21c is configured to determine the compensating torques T_{L} and T_{R}. Because the mass M of the door 10 and the distance L_{cg} between the rotation shaft S and the center of gravity C.G of the door 10 are constant values obtained from specifications of the door 10, when only the transverse gravitational forces L_{y} and R_{y} acting on the door 10 are obtained, the compensating torques T_{L} and T_{R} may be also determined.

Meanwhile, when the gravitational forces L_{y} and R_{y} acting on the door 10 act in the direction of closing the door 10, this was defined as a positive (+), and when the gravitational forces L_{y} and R_{y} acting on the door 10 act in the direction of opening the door 10, this was defined as a negative (−). Therefore, when the compensating torques T_{L} and T_{R} are determined as the positive (+), the compensating torques T_{L} and T_{R} need to act on the rotation shaft S in the direction of opening the door 10, and when the compensating torques T_{L} and T_{R} are determined as the negative (−), the compensating torques T_{L} and T_{R} need to act on the rotation shaft S in the direction of closing the door 10.

The driving controller 22 allows the actuator 11 to output the compensating torques T_{L} and T_{R} determined by the control amount calculator 21, particularly, the compensating torque calculator 21c. When the door 10 is opened or closed by the occupant, the driving controller 22 is configured to control the actuator 11 to output the compensating torques T_{L} and T_{R}.

However, when absolute values of the compensating torque T_{L} and T_{R} determined by the compensating torque calculator 21c are not greater than a predetermined reference torque THD, the driving controller 22 does not allow the actuator 11 to output the compensating torques T_{L} and T_{R}.

When the vehicle stops on a road surface with a small inclination angle, the manipulating force for opening or closing the door 10 may not be significantly different from that of a flat road, and thus even when the compensating torques T_{L} and T_{R} act through the actuator 11, the occupant does not feel this. Therefore, only when the reference torque THD is set and the determined compensating torques T_{L} and T_{R} are greater than the reference torque THD, the driving controller 22 may be configured for controlling the actuator 11 to output the compensating torques T_{L} and T_{R}.

A method of compensating for a door operating force on an inclined road surface according to an exemplary embodiment of the present disclosure will be described as follows.

The method of compensating for the door operating force on the inclined road surface according to an exemplary embodiment of the present disclosure may be performed by the above-described system for compensating for the door operating force on the inclined road surface.

The method of compensating for the door operating force on the inclined road surface according to an exemplary embodiment of the present disclosure includes a signal input operation S110 of inputting sensor signals required for determining the compensating of the operating force of the door 10 to the controller 12, a stop determination operation S120 of determining, by the controller 12, whether the vehicle 1 is stopping, a gravitational force determination operation S130 of determining, by the controller 12, the gravitational forces L_{y} and R_{y} acting in the transverse direction of the door 10 with the input sensor signals, a compensating torque determination operation S140 of determining, by the controller 12, the compensating torques T_{L} and T_{R} to be output from the actuator 11 to offset the gravitational forces L_{y} and R_{y}, and an operating force compensation operation S160 of compensating for, by the controller 12, the operating force when the door 10 is opened or closed with the compensating torques T_{L} and T_{R}.

In the signal input operation S110, the sensor signals required for determining the compensation for the operating force of the door 10 may be input to the controller 12.

To compensate for the operating force of the door 10, because it is necessary to know the state of the vehicle, the inclination angle of the road surface, and the like, the sensor signals may be input to the controller 12 through the signal input operation S110.

In the signal input operation S110, each wheel speed may be input. For example, when the vehicle is provided with four wheels, the wheel speed Whl_Spd_{FL} of the front left wheel, the wheel speed Whl_Spd_{FR} of the front right wheel, the wheel speed Whl_Spd_{RL} of the rear left wheel, and the wheel speed Whl_Spd_{RR} of the rear right wheel may be input. Furthermore, the gear position of the vehicle, whether the brake pedal operates, and the pressure of the master cylinder according to the operation of the brake pedal may be input. Furthermore, when the door lock of the door is being locked, it is not necessary to compensate for the torque when the door is opened or closed, and since it is necessary to compensate for the operating force because the door 10 may be opened or closed only in an unlocked state, whether the door lock is locked is also input.

Furthermore, in the signal input operation S110, the longitudinal acceleration Aₓ, the transverse acceleration A_{y}, and the opening angle α of the door 10 may be also input.

In the stop determination operation S120, the controller 12 is configured to determine whether the vehicle has stopped from the input sensor signals.

In the stop determination operation S120, the controller 12 is configured to determine that the vehicle is stopping when the state in which each wheel speed of the vehicle is 0 kph and the gear position is in the P stage is maintained for the preset time or longer than the preset time. This is a condition for determining whether the vehicle stops when the gear is in the state of being the P stage.

Alternatively, it is possible to determine whether a driver manipulates the brake pedal to stop the vehicle when the gear is not in the P stage, that is, in a situation in which the gear is in an R, N, or D stage. That is, in the stop determination operation S120, the controller 12 is configured to determine that the vehicle is stopping when a state in which each wheel speed of the vehicle is 0 kph, the brake pedal is in operation, and the pressure of the master cylinder is higher than or equal to the preset value is maintained for the preset time or longer than the preset time.

In the stop determination operation S120, when the vehicle is not stopping, a logic may be ended.

In the stop determination operation S120, it is determined whether the door lock is in the unlocked state. Even when the vehicle is stopping, because the door 10 is not opened in the state in which the door lock is locked, it is not necessary to compensate for the operating force for opening or closing the door 10. Therefore, when the door lock is unlocked after it is determined whether the door lock is unlocked, each operation to be described below may be performed.

In the gravitational force determination operation S130, the controller 12 is configured to determine the gravitational forces L_{y} and R_{y} acting in the transverse direction of the door 10 with the input sensor signals. In the gravitational force determination operation S130, the controller 12 is configured to determine the transverse gravitational forces L_{y} and R_{y} due to the weight of the door 10 and the inclination of the road surface after the vehicle has stopped on the inclined road surface. In the gravitational force determination operation S130, the gravitational forces L_{y} and R_{y} may be determined from the longitudinal acceleration Aₓ and a transverse acceleration A_{y} applied to the vehicle, and the opening angle α of the door 10.

In the gravitational force determination operation S130, the gravitational forces L_{y} and R_{y} acting on the left and right doors may be determined by the following equation.

The gravitational forces L_{y} and R_{y} acting on the door 10 may be expressed as follows by the above-described inducing process.

Gravitational force acting on the left door: L_{y}(θ,φ,α)=−g·sin θ·sin α+g·sin φ·cos θ·cos α

Gravitational force acting on the right door: R_{y}(θ,φ,α)=−g·sin θ·sin α−g·sin φ·coxθ·cos α

(Here, α: opening angle of the door, θ: longitudinal inclination, and φ: transverse inclination)

In the compensating torque determination operation S140, the compensating torques T_{L} and T_{R} to be output from the actuator in order to offset the gravitational forces L_{y} and R_{y} may be determined. The gravitational forces L_{y} and R_{y} act on the center of gravity of the door 10, which generates torques with respect to the rotation shaft S of the door 10. Because the generated torque needs to be offsetted, the magnitudes of the compensating torque T_{L} and T_{R} may be determined through the compensating torque determination operation S140. That is, according to an exemplary embodiment of the present disclosure, the gravitational forces L_{y} and R_{y} need to be canceled with the compensating torques T_{L} and T_{R} including the same magnitude as that of the torque generated by the transverse gravitational forces L_{y} and R_{y} and opposite directions, and in the compensating torque determination operation S140, the compensating torques T_{L} and T_{R} to be output from the actuator 11 may be determined. The compensating torques T_{L} and T_{R} obtained in the compensating torque determination operation S140 may be output from the actuator 11 in the operating force compensation operation S160 to be described below.

In the compensating torque determination operation S140, the compensating torques T_{L} and T_{R} to be applied to the left door 10 and the right door 10 of the vehicle may be determined by the following equation:

Compensating torque of the left door: T_{L}=M·L_{cg}·L_{y}, and

Compensating torque of the right door: T_{R}=M·L_{cg}·R_{y}

Here, M: mass of the door, L_{cg}: distance between the rotation shaft of the door and the center of gravity, and L_{y} and R_{y}: gravitational forces acting on each of the left door and the right door.

In a compensating torque comparison operation S150, the absolute values of the compensating torque T_{L} and T_{R} may be compared with the predetermined reference torque THD that requires the compensation of the operating force. When the magnitudes of the compensating torque T_{L} and T_{R}, that is, the absolute values of the compensating torque T_{L} and T_{R} are not large, that is, when the vehicle stops on the road surface with the small inclination angle, the operating force for opening or closing the door 10 may not be significantly different from that of the flat road.

Therefore, even when the compensating torques T_{L} and T_{R} are applied, the occupant may not feel the compensating torques T_{L} and T_{R}, and thus by comparing the absolute values of the compensating torques T_{L} and T_{R} with the reference torque THD, it is determined whether the compensating torques T_{L} and T_{R} are applied.

The operating force compensation operation S160 may be performed when the absolute values of the compensating torque T_{L} and T_{R} are greater than the reference torque THD in the compensating torque comparison operation S150. In the operating force compensation operation S160, the controller 12 compensates for the operating force with the compensating torques T_{L} and T_{R} when the door 10 is opened or closed. The controller 12 is configured to control the actuator 11 to output the compensating torques T_{L} and T_{R} when the occupant opens or closes the door 10, and compensates for the occupant's operating force for opening or closing the door 10.

When the compensating of the operating force when the door 10 is opened or closed by the operating force compensation operation S160 is completed, the method returns to the signal input operation S110.

A period for which the method is returned to the signal input operation S110 may be a predetermined time period. For example, by setting the period for which the method returns to the signal input operation S110 to 100 ms, the logic may be repeatedly performed every 100 ms.

Meanwhile, in a state in which the opening and closing of the door 10 is unnecessary, for example, the logic may be ended in a state in which the door lock is locked. When the opening and closing of the door 10 is unnecessary, the logic may be ended because it is not necessary to compensate for the operating force required for opening or closing the door 10.

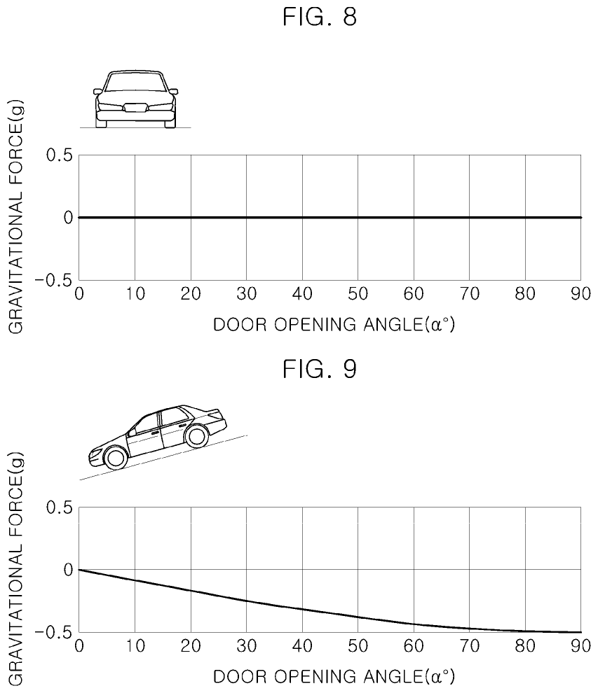

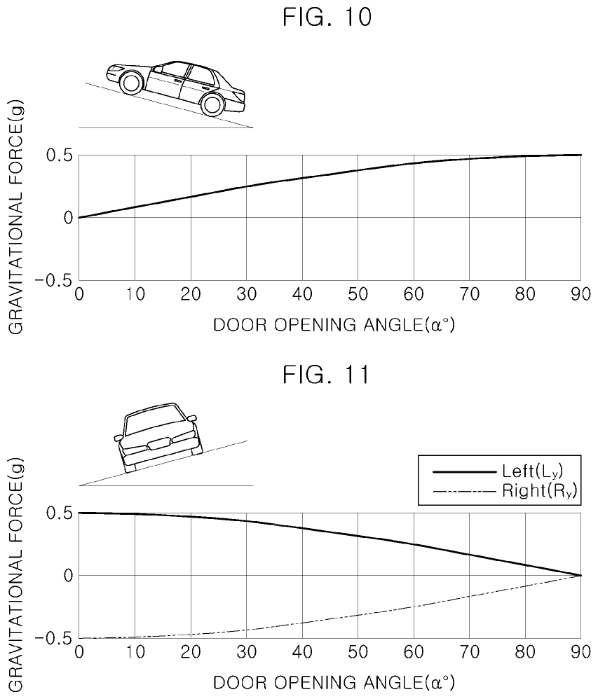

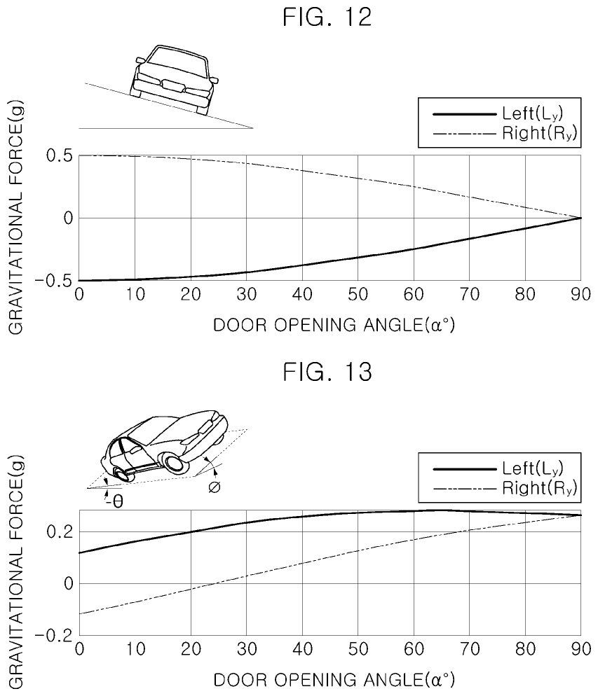

FIGS. 8 to 13 illustrate the transverse gravitational force acting on the door 10 according to the inclination of the road surface on which the vehicle 1 has stopped. Because the transverse gravitational forces acting on the left door 10 and the right door 10 are the same, the transverse gravitational forces are illustrated in FIG. 8, FIG. 9 and FIG. 10 without distinction, and the transverse gravitational forces acting on the left door 10 and the right door 10 are illustrated separately in FIG. 11, FIG. 12 and FIG. 13.

FIG. 8 illustrates the gravitational force acting on the door 10 in the state in which the vehicle 1 stops on the flat road. When the vehicle 1 stops on the flat road, the gravitational force does not act on the door 10.

FIG. 9 illustrates that because the vehicle 1 stops on a downward inclined surface (inclined surface including the front of the vehicle lower than the rear of the vehicle), the gravitational force acts on the door 10 with the front and rear inclination angle of 30 degrees and the longitudinal acceleration Aₓ of −0.5 g. That is, when “θ=30, φ=0” is substituted with L_{y} (θ, φ, α) and R_{y} (θ, φ, α), the result becomes “L_{y} (θ, φ, α)=−0.5 g·sin α,” and “R_{y} (θ, φ, α)=−0.5 g·sin α,” and as illustrated in FIG. 9, because the door 10 is opened and the opening angle α increases, the gravitational force also increases The gravitational forces for opening the door 10 act on the door 10. As described above, because the gravitational forces are defined as the negative (−) when acting in the direction of opening the door 10, as the opening angle of the door 10 increases, the gravitational forces tend to change in a decreasing direction (the absolute values tend to continuously increase as the gravitational forces change in the negative direction). In the instant case, a lot of force may be required to close the door 10.

FIG. 10 illustrates the gravitational forces acting on the door 10 in a state in which the vehicle 1 has stopped on an upward inclined surface (a gravitational force of up to 0.5 g acts on the door 10 at an inclination angle of 30 degrees). The gravitational force acting on the door 10 tends to increase in a direction opposite to that of FIG. 9.

FIG. 11 illustrates that because the vehicle 1 stops on an inclined surface having the left side higher than the right side of the vehicle 1, the gravitational forces act on the door 10 with the left and right inclination angle φ of 30 degrees and the transverse acceleration A_{y} of −0.5 g.

Because the right side of the vehicle is low, a negative (−) gravitational force acts on the right door and a positive (+) gravitational force acts on the left door. When the right door and the left door are closed, the greatest gravitational forces act on the right and left doors, and the magnitudes of the gravitational forces may be reduced as the right and left doors are opened.

FIG. 12 illustrates a tendency opposite to FIG. 11 as a state in which the vehicle 1 stops on an inclined surface having the right side higher than the left side of the vehicle 1.

FIG. 13 illustrates a state in which the vehicle 1 stops on an inclined surface having a front left side higher than a rear right side of the vehicle 1.

Even when there is an inclination in the front and rear direction and the left and right direction of the vehicle at the same time, the gravitational forces acting on the door 10 may be determined by the above-described equation. For example, when the front and rear inclination angle θ is −15 degrees and the left and right inclination angle φ is 7 degrees, the longitudinal acceleration Aₓ and the transverse acceleration A_{y} act as 0.26 g and 0.12 g, respectively, and the gravitational forces vary as the door is opened or closed to act on the door 10, and the compensating torques for compensating for the changed gravitational forces may be applied.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system of compensating for an operating force of a door on an inclined road surface, the system comprising:
the door opened or closed by rotating about a rotation shaft of a body of a vehicle;
an actuator coupled to the door and configured to operate the door with compensating torques for offsetting gravitational forces acting on the door by a weight of the door and gravity; and
a controller electrically connected to the actuator and configured to determine the gravitational forces acting on the door, determine the compensating torques to offset the gravitational forces, and compensate for the operating force of the door in response that the door is opened in a state in which the vehicle has stopped on the inclined road surface.

2. The system of claim 1, wherein the controller includes:
a control amount calculator configured to determine the gravitational forces applied to the door and to determine the compensating torques; and
a driving controller configured to drive the actuator to operate the door with the compensating torques determined by the control amount calculator.

3. The system of claim 2, wherein the control amount calculator includes:
a stop determiner configured to determine whether the vehicle has stopped;
a gravitational force calculator configured to determine a gravitational force applied to the door in a transverse direction of the vehicle; and
a compensating torque calculator configured to determine the compensating torques to be output from the actuator to offset the gravitational forces.

4. The system of claim 3, wherein the stop determiner is configured to determine that the vehicle is stopping in response that a state in which each wheel speed of the vehicle is 0 kph and a position of a gear is in a P stage is maintained for a preset time or longer than the preset time.

5. The system of claim 3, wherein the stop determiner is configured to determine that the vehicle is stopping in response that a state in which each wheel speed of the vehicle is 0 kph, a braking pedal of the vehicle is in operation, and a pressure of a master cylinder in the vehicle is a preset value or higher than the preset value is maintained for a preset time or longer than the preset time.

6. The system of claim 3,
wherein the door includes a left door and a right door, and
wherein the gravitational force calculator is configured to determine the gravitational forces acting on the left door and the right door of the vehicle, respectively after receiving a longitudinal acceleration and a transverse acceleration applied to the vehicle, and an opening angle of the left door and the right door.

7. The system of claim 6, wherein the gravitational force calculator is configured to determine the gravitational forces acting on the left door and the right door of the vehicle, respectively, by the following equation:
Gravitational force acting on the left door: L_{y}(θ,φ,α)=−g·sin θ·sin α+g·sin φ·cos θ·cos α, and
Gravitational force acting on the right door: R_{y}(θ,φ,α)=−g·sin θ·sin α−g·sin φ·coxθ·cos α,
wherein α is the opening angle of the left door and the right door, θ is the longitudinal inclination, and φ is the transverse inclination.

8. The system of claim 3,
wherein the door includes a left door and a right door, and
wherein the compensating torque calculator is configured to determine the compensating torques of the left door and the right door of the vehicle by the following equation:
Compensating torque of the left door: T_{L}=M·L_{cg}·L_{y}, and
Compensating torque of the right door: T_{R}=M·L_{cg}·R_{y},
wherein M is a mass of the door, L_{cg} is a corresponding distance between the rotation shaft of the left door and the center of gravity and between the rotation shaft of the right door and the center of gravity, and Ly and R_{y} are gravitational forces respectively acting on the left door and the right door.

9. The system of claim 2, wherein the driving controller is configured to compensate for opening and closing forces of the door with the compensating torques in response that absolute values of the compensating torques are greater than a predetermined reference torque at which the compensating of the operating force for opening or closing the door is required.

10. A method of compensating for an operating force of a door on an inclined road surface, the method comprising:
a signal input operation of inputting sensor signals, which are required for determining the compensating of the operating force of the door, to a controller;
a stop determination operation of determining, by the controller, whether a vehicle is stopping;
a gravitational force determination operation of determining, by the controller, gravitational forces acting on the door in a transverse direction of the vehicle with the input sensor signals;
a compensating torque determination operation of determining, by the controller electrically connected to the an actuator, compensating torques to be output from the actuator to offset the gravitational forces; and
an operating force compensation operation of compensating, by the controller, for the operating force in response that the door is opened or closed with the compensating torques.

11. The method of claim 10, wherein the stop determination operation includes determining that the vehicle is stopping in response that a state in which each wheel speed of the vehicle is 0 kph and a position of a gear is in a P stage is maintained for a preset time or longer than the preset time.

12. The method of claim 10, wherein the stop determination operation includes determining that the vehicle is stopping in response that a state in which each wheel speed of the vehicle is 0 kph, a braking pedal of the vehicle is in operation, and a pressure of a master cylinder in the vehicle is a preset value or higher than the preset value is maintained for a preset time or longer than the preset time.

13. The method of claim 10,
wherein the door includes a left door and a right door, and
wherein in the gravitational force determination operation, the gravitational forces acting on the left door and the right door of the vehicle, respectively are determined by the following equation:
Gravitational force acting on the left door: L_{y}(θ,φ,α)=−g·sin θ·sin α+g·sin φ·cos θ·cos α, and
Gravitational force acting on the right door: R_{y}(θ,φ,α)=−g·sin θ·sin α−g·sin φ·coxθ·cos α
wherein α is the opening angle of the left door and the right door, θ is the longitudinal inclination, and φ is the transverse inclination.

14. The method of claim 12,
wherein the door includes a left door and a right door, and
wherein in the compensating torque determination operation, the compensating torques of the left door and the right door of the vehicle are determined by the following equation:
Compensating torque of the left door: T_{L}=M·L_{cg}·L_{y}, and
Compensating torque of the right door: T_{R}=M·L_{cg}·R_{y}
wherein M is a mass of the door, L_{cg} is a corresponding distance between the rotation shaft of the left door and the center of gravity and between the rotation shaft of the right door and the center of gravity, and Ly and R_{y} are gravitational forces respectively acting on the left door and the right door.

15. The method of claim 10, further including a compensating torque comparison operation of comparing absolute values of the compensating torques with a predetermined reference torque at which the compensating of the operating force is required between the compensating torque determination operation and the operating force compensation operation,
wherein in the compensating torque comparison operation, the operating force compensation operation is performed in response that the absolute values of the compensating torques are greater than the predetermined reference torque.

16. The method of claim 10, wherein the signal input operation includes inputting a signal including each wheel speed, a position of a gear, whether a braking pedal of the vehicle is operated, a pressure of a master cylinder in the vehicle, whether a door lock of the vehicle is opened or closed, a longitudinal acceleration, a transverse acceleration, and an opening angle of the door to the controller.

17. The method of claim 10, wherein in stop determination operation, whether the door lock of the door is in an unlocked state is determined, and
in response that the door lock is unlocked, the gravitational force determination operation is performed.

18. The method of claim 17, further including a locking determination operation of determining whether the door lock is in the unlocked state after the operating force compensation operation,
in response that the door lock is not in the unlocked state, the method returns to the signal input operation.

19. The method of claim 10, wherein the controller is configured to repeatedly perform the signal input operation to the operating force compensation operation every predetermined period.
